(19) United States
(12) Patent Application Publication
(10) Pub. No.: US 2020/0015594 A1
(43) Pub. Date: Jan. 16, 2020

(54) ADJUSTMENT DEVICE FOR A HEADREST

(71) Applicant: CIAR S.P.A., Pesaro (IT)

(72) Inventor: Massimo Carrera, Pesaro (IT)

(21) Appl. No.: 16/508,361

(22) Filed: Jul. 11, 2019

(30) Foreign Application Priority Data
Jul. 12, 2018 (DE) 20 2018 104 018.9

(51) Int. Cl. A47C 7/38; B60N 2/829; B60N 2/853

(52) U.S. Cl. CPC A47C 7/38; B60N 2/853; B60N 2/829

(57) ABSTRACT

An adjustment device for a headrest includes: a frame, a tilt adjustment device serving to adjust the headrest inclination and including at least one support element for securing the headrest. The tilt adjustment device includes: a height adjustment device including at least one tube, wherein the support element is swivelable about a swivel axis at an end portion of the tube, with the tube slidably guided in the frame, enabling the headrest to be height-adjustable relative the frame, and at least one drive means connected to the height adjustment device and operatively connected to the tube for displacing same. A rod is guided inside the tube and coupled at one of its ends with the support element, a displacement of the rod relative to the tube causing the support element to swivel about the swivel axis, thereby effecting an adjustment of the inclination of the headrest.

The invention relates to an adjustment device for a headrest such as those used in furniture for sitting or lying, particularly in a chair or sofa. Other exemplary applications such as automobile seats or the like, are also conceivable, however.

In general, both the height and inclination of a headrest can be adjusted in order to enhance the user's comfort. Comfort is further improved by a drive means for motorized adjustment of the headrest. Electrically adjustable headrests are known, for example, from DE 20 2018 100 399 U1, DE 20 2018 100 158 U1, or DE 199 83 415 B4. Nevertheless, the known solutions are often very expensive.

It is therefore the object of the invention to provide an adjustment device for a headrest that has a simple and compact construction.

According to the invention, this object is achieved by the features of claim 1.

The adjustment device according to the invention for a headrest has essentially the following features:
a frame,
a tilt adjustment device with which the inclination of the headrest can be adjusted, with the tilt adjustment device comprising at least one support element for securing the headrest,
a height adjustment device comprising at least one tube, wherein the support element for securing the headrest is supported so as to be swivelable about a swivel axis at an end portion of the tube, and the tube is slidably guided in the frame, thus enabling the headrest to be height-adjustable relative to the frame, and
at least one drive means that is connected to the height adjustment device and is operatively connected to the tube for the purpose of displacing same.

The tilt adjustment device further comprises a rod that is guided inside the tube and coupled at one of its ends with the support element, with a displacement of the rod relative to the tube causing the support element to swivel about the swivel axis, thereby effecting an adjustment of the inclination of the headrest.

By virtue of the construction according to the invention, only the at least one, preferably two tubes of the height adjustment device are visible between the frame, which is usually arranged at the upper end of a backrest, and the headrest, resulting in a very clear and pleasing outward design. As a result of the rod that is guided in the at least one tube for the purpose of positioning and inclining the headrest, no other moving parts of the adjustment device are visible, either.

Additional advantages and embodiments of the invention constitute the subject matter of the subclaims.

According to a preferred embodiment of the invention, the coupling of the support element (for fastening the headrest) with the rod is achieved by means of an articulated arm that is hingedly connected at one end to the rod and is hingedly connected at another end to the support element. Moreover, the drive means can be instantiated by a linear actuator that is coupled at one end with the frame and operatively connected at its other end to the at least one tube for the displacement thereof.

Furthermore, a connecting piece is expediently attached to the tube for the purpose of swivelably supporting the support element (7a, 7b), with the connecting piece having a stop element for limiting the swiveling movement of the support element and thus limiting the inclining movement of the headrest.

According to a preferred exemplary embodiment, the rod protrudes with a portion out of the tube at the end of the tube that faces away from the support element, with the drive means being secured to this portion by means of a fastening element. Moreover, it is possible for a spring element to be pushed up onto the portion and supported with one end on the tube and with another end on the fastening element, with an actuation of the drive means from a lower position of the headrest initially effecting a limited displacement of the tube and thus a displacement of the headrest into an upper position, and with a further actuation of the drive means effecting a displacement of the rod relative to the tube under compression of the spring element, so that the headrest is tilted.

The tube can have a stop that cooperates with at least one abutment that is provided on the frame in order to limit the translational movement of the tube. With this construction, both the height adjustment and the inclination adjustment of the headrest can be performed using a single drive means. However, it must then be accepted that the inclination of the headrest occurs only once the headrest has been fully raised, that is, up to the stop. Nevertheless, an optimized user setting can still be achieved by making the stop adjustable.

Nonetheless, the inventive construction according to the features of claim 1 even allows the inclination of the headrest to be adjusted regardless of the height position of the headrest if two drive means are provided—one for the height adjustment and one for the inclination adjustment. In this second exemplary embodiment, the drive mechanism comprises a first and a second drive unit, with the first drive unit being coupled with the tube for the purpose of displacing same and the second drive unit being coupled with the rod for the purpose of displacing same relative to the tube. In particular, the first drive unit can be coupled via a first fastening element with the tube, while the second drive unit is supported on the first fastening element and coupled via a second fastening element with the at least one rod.

Additional embodiments and advantages of the invention will be explained in greater detail in the following description of two exemplary embodiments and the drawing:

In the drawing:

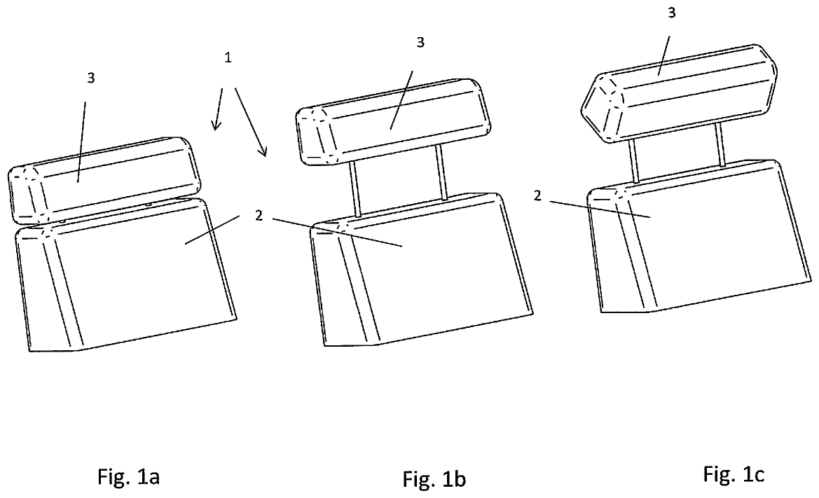

FIGS. 1a to 1c show a three-dimensional representation of the headrest in three different positions,

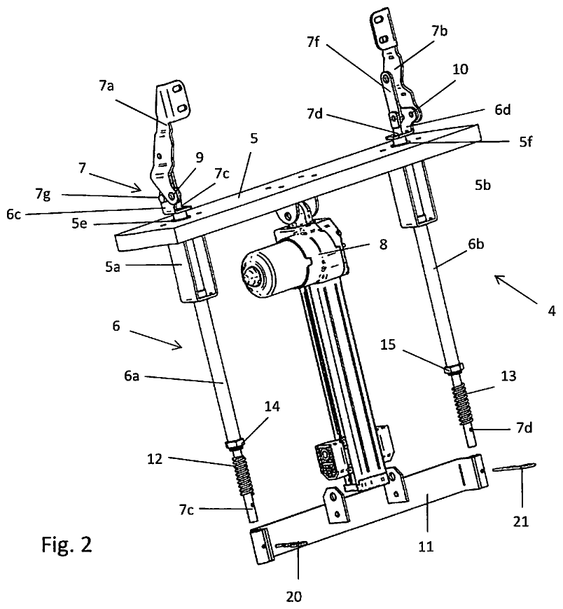

FIG. 2 shows a three-dimensional exploded view of the adjustment device according to a first exemplary embodiment,

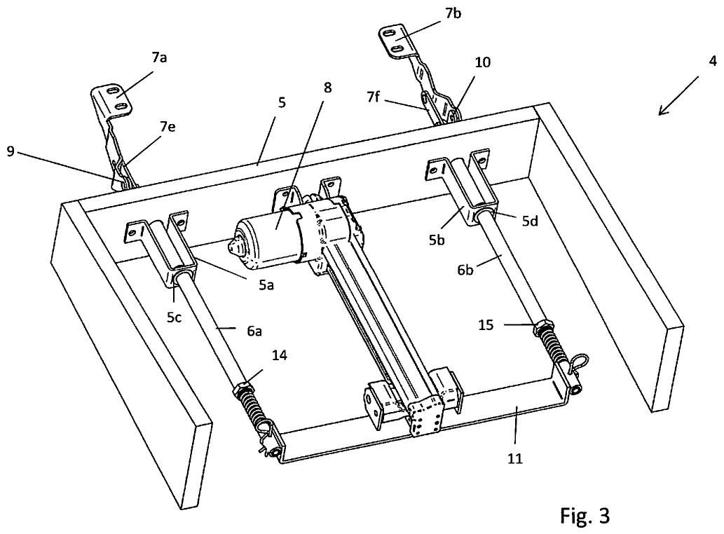

FIG. 3 shows a three-dimensional representation of the adjustment device according to FIG. 2 in the assembled state,

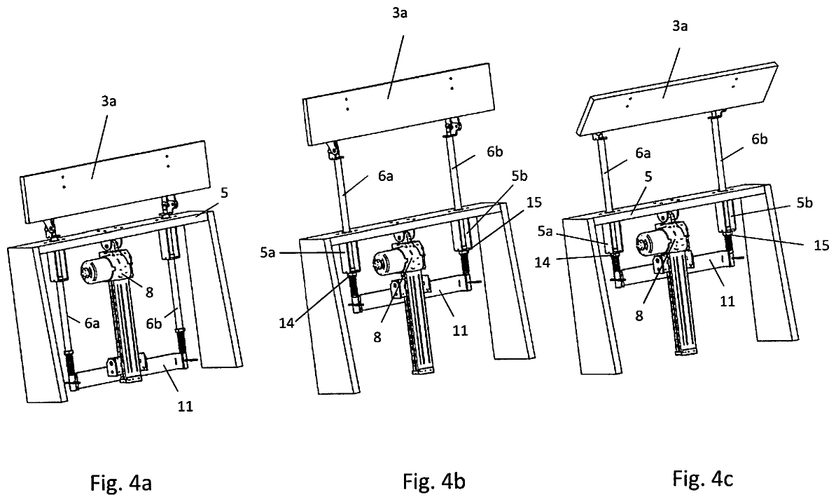

FIGS. 4a to 4c show three-dimensional representations of the adjustment device according to the first exemplary embodiment with different positions of the headrest,

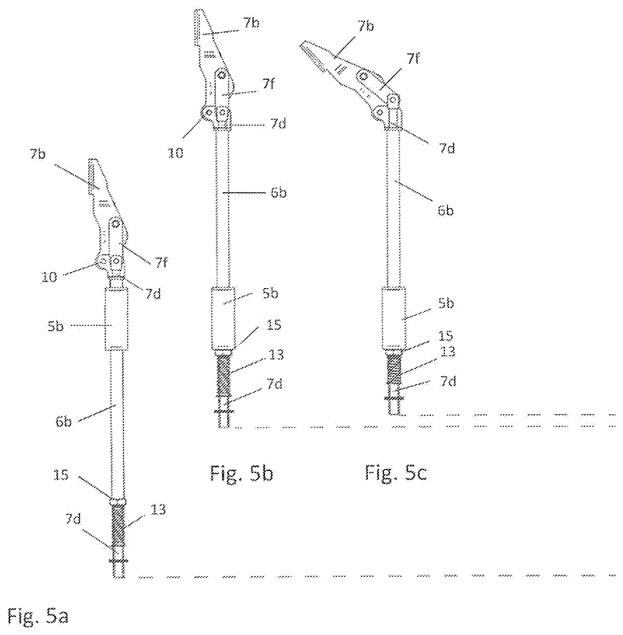

FIGS. 5a to 5c show representations of the adjustment device in the different positions of the headrest,

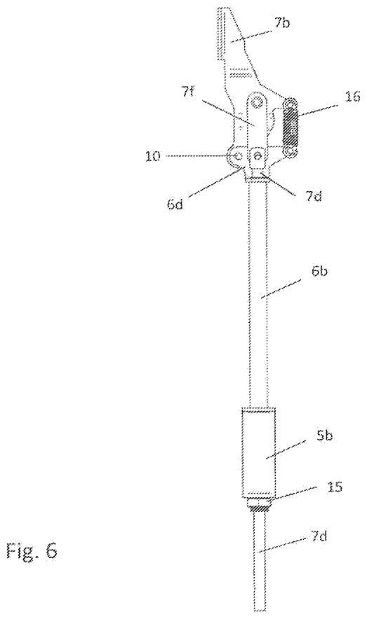

FIG. 6 shows a side view of a tilt adjustment device according to a second exemplary embodiment, and

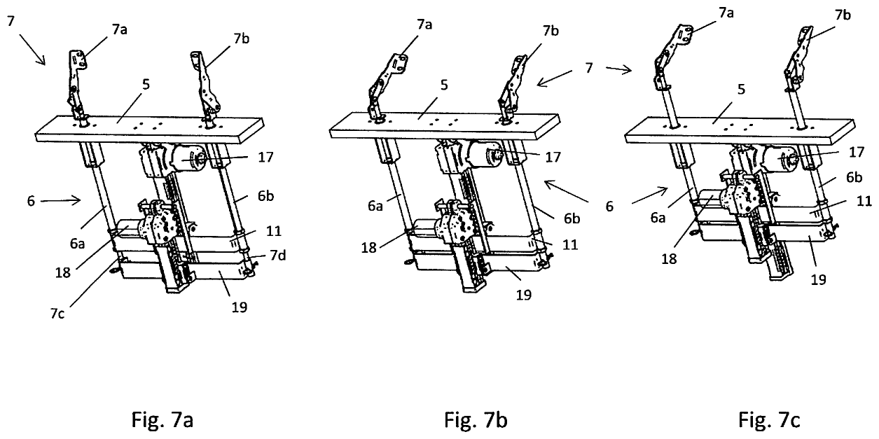

FIGS. 7a to 7c show three-dimensional representations of the adjustment device according to a second exemplary embodiment with different positions of the headrest.

In FIGS. 1a to 1c, a portion of a piece of furniture 1 for sitting or lying is shown with a backrest 2 and a headrest 3, with the headrest 3 being in the retracted state in FIG. 1a, in the raised state in FIG. 1b, and in the raised and inclined state in FIG. 1c.

In order to achieve the different positions of the headrest 3, an adjustment device 4 shown in FIG. 2 is provided that comprises a frame 5, a height adjustment device 6, a tilt adjustment device 7, and a drive means 8. The height adjustment device has two tubes 6a, 6b that are supported on the frame 5 so as to be displaceable on the frame between a lower position (FIG. 4a) and an upper position (FIG. 4b). For this purpose, two spaced-apart guide profiles 5a, 5b are provided on the frame 5, each having a borehole 5c or 5d (FIG. 3) that is aligned with spaced-apart boreholes 5e, 5f (FIG. 2) in the frame and act as guides for the rods 6a and 6b.

A respective support element 7a, 7b of the tilt adjustment device 7 is hinged on the upper end of the two tubes 6a, 6b so as to be swivelable about a swivel axis 9, 10. The two support elements 7a, 7b are connected to one another by means of a connecting plate 3a (FIGS. 4a to 4c). The connecting element 3a forms the headrest 3 together with a padding (not shown in greater detail).

The tilt adjustment device has a first rod 7c and a second rod 7d, each of which is displaceably guided in the first and second tube 6a, 6b, respectively. The two rods 7c, 7d have an upper end that protrudes from the two tubes 6a, 6b at the upper end thereof and is hingedly connected there via an articulated arm 7e, 7f to the associated support element 7a, 7b, respectively. The lower ends of the two rods 7c, 7d also protrude downward out of the two tubes 6a, 6b, respectively, with the two ends of the rods 7c, 7d being interconnected via a first fastening element 11. The drive means 8 is embodied as a linear actuator and secured between the two rods 6a, 6b with one end on the frame 5. The opposite end of the drive means 8 is connected to the first fastening element 11. A respective spring element 12, 13 is pushed onto the downwardly projecting portions of the rods 7c, 7d. During assembly, the fastening element 11 is then pushed onto the two portions of the two rods 7c, 7d and secured by brackets 20, 21. The spring elements 12, 13 are thus supported at one end on the two tubes 6a, 6b and at the other end on the fastening element 11 (FIG. 3).

Actuation of the drive means 8 from the lower position of the headrest 3 shown in FIG. 4a initially causes limited displacement of the two tubes 6a, 6b and thus a displacement of the headrest 3 into the upper position shown in FIG. 4b. To limit the translational movement of the two tubes 6a, 6b, stops 14, 15 are provided at the lower ends of the tubes that are instantiated here by nuts that are screwed onto the ends of the tubes 6a, 6b. In the upper position according to FIG. 4b, these stops 14, 15 come into contact with the abutments of the frame 5 instantiated by the guide profiles 5a, 5b and thereby limit further displacement of the two rods 6a, 6b (FIGS. 4a and 4b; FIGS. 5a and 5b).

Further actuation of the drive means 8 in the same direction now causes a displacement of the two rods 7c, 7d relative to the two tubes 6a, 6b, with the spring elements 12, 13 being compressed. At the same time, the two rods 7c, 7d slide out of the two tubes 6a, 6b at the upper end thereof and effect a tilting of the two support elements 7a, 7b via the two articulated arms 7e, 7f about the swivel axes 9, 10 (FIG. 4c; FIG. 5c).

An opposite actuation of the drive means 8 initially results in a shifting of the inclination of the headrest from the position shown in FIG. 4c into the position shown in FIG. 4b. Further actuation of the drive means would move the headrest into the lower position shown in FIG. 4a. In order to limit the swiveling movement of the support elements 7a, 7b into the position shown in FIG. 4b, each support element 7a and 7b cooperates with a stop element 7g that is respectively provided on a connecting element 6c and 6d, which are securely connected to the upper ends of the tubes 6a, 6b and with which the two support elements 7a, 7b are hingedly coupled about the swivel axes 9, 10.

FIG. 6 shows yet another alternative exemplary embodiment of the tilt adjustment device in which the function of the spring elements 12 and 13 is realized by spring elements 16 that are not arranged on the portions of the rods 7c, 7d that project out at the lower end of the tubes 6a, 6b, but rather between the connecting elements 6c and 6d and the support elements 7a and 7b, respectively. Here, too, the spring elements 16 initially cause a displacement of the tubes 6a and 6b until the stops 14 and 15 come into contact with the guide profiles 5a and 5b. Further displacement of the rod 7c and 7d upward would then cause an inclination of the support member 7c or 7b against the force of the spring element 16.

In the adjustment device that is described above according to a first exemplary embodiment, only one drive means 8 is used with which both the height and the inclination of the headrest 3 can be adjusted. For this purpose, the headrest 3 must first be fully extended until the tilting of the headrest 3 can occur. The height of the headrest can be optionally adjusted by means of stops 14, 15 that can be displaced along the tubes 6a, 6b. In the depicted exemplary embodiment, the stops 14, 15 are instantiated by nuts 14 that can be screwed onto an external thread of the tubes 6a, 6b and, optionally, adjusted.

It would therefore be substantially more comfortable if the height and inclination of the headrest could be adjusted independently of one another. Such an adjustment device according to a second embodiment is shown in FIGS. 7a to 7c. The height adjustment device 6 and the tilt adjustment device 7 are embodied in a manner that is substantially congruent with the first embodiment. Instead of a single drive means 8, however, a first drive unit 17 and a second drive unit 18 are used in this second exemplary embodiment. Similarly to the drive unit 8, the first drive unit 17 is plugged via the fastening element 11 onto the portions of the rods 7c, 7d protruding below from the tubes 6a, 6b and is operatively connected to the ends of these tubes so as to enable displacement of the two tubes 6a, 6b. The operating principle of the first drive unit 17 thus corresponds substantially to that of the drive unit 8 from the first exemplary embodiment. Upon actuation of the first drive means 17, a displacement of the two tubes 6a, 6b occurs from the position according to FIG. 7a into the position shown in FIG. 7c. The second drive unit 18 is supported on the fastening element 11 and thus moves together therewith. However, the second drive unit 18 is coupled at its other end via a second fastening element 19 with the portions of the rods 7c and 7d that protrude from the tubes 6a, 6b. If the second drive unit 18 is actuated such that the distance between the fastening element 11 and the second fastening element 19 is shortened, the two rods 7c, 7d are displaced in the tubes 6a and 6b and thereby effect an adjustment of the inclination of the support elements 6a, 6b of the headrest 3, as can be seen by comparing the images of FIGS. 7a and 7b.

The second exemplary embodiment thus enables the inclination of the headrest 3 to be adjusted independently of a height adjustment.

1. An adjustment device (4) for a headrest (3), comprising
a frame (5),
a tilt adjustment device (7) with which the inclination of the headrest (3) can be adjusted, with the tilt adjustment device (7) comprising at least one support element (7a, 7b) for securing the headrest (3),
a height adjustment device (6) comprising at least one tube (6a, 6b), wherein the support element (7a, 7b) for securing the headrest (3) is supported so as to be swivelable about a swivel axis (9, 10) at an end portion of the tube (6a, 6b), and the tubes (6a, 6b) is slidably guided in the frame (5), thus enabling the headrest (3) to be height-adjustable relative to the frame (5), and
at least one drive means (8; 17, 18) that is connected to the height adjustment device (6) and is operatively connected to the tube (6a, 6b) for the purpose of displacing same,
characterized in that the tilt adjustment device (7) comprises a rod (7c, 7d) that is guided inside the tube (6a, 6b) and coupled at one of its ends with the support element (7a, 7b), with a displacement of the rod (7c, 7d) relative to the tube (6a, 6b) causing the support element (7a, 7b) to swivel about the swivel axis (9, 10), thereby effecting an adjustment of the inclination of the headrest (3).

2. The adjustment device as set forth in claim 1, characterized in that the coupling of the support element (7a, 7b) with the rod (7c, 7d) is achieved by means of an articulated arm (7e, 7f) that is hingedly connected at one end to the rod (7c, 7d) and is hingedly connected at another end to the support element (7a, 7b).

3. The adjustment device as set forth in claim 1, characterized in that the drive means (8; 17, 18) is instantiated by a linear actuator that is coupled at one end with the frame (5) and is operatively connected to the tube (6a, 6b) at its other end.

4. The adjustment device as set forth in claim 1, characterized in that, for the purpose of swivelably supporting the support element (7a, 7b) on the tube (6a, 6b), a connecting element (6c, 6d) is attached that has a stop element (7g) for limiting the swiveling movement of the support element (7a, 7b).

5. The adjustment device as set forth in claim 1, characterized in that the rod (7c, 7d) protrudes with a portion out of the tube (6a, 6b) at the end of the tube (6a, 6b) that faces away from the support element (7a, 7b), and the drive means (8; 17, 18) is fastened to this portion by means of a fastening element (11; 19).

6. The adjustment device as set forth in claim 5, characterized in that a spring element (12, 13) is pushed up onto the portion and is supported with one end on the tube (6a, 6b) and with another end on the fastening element (11; 19), with an actuation of the drive means (8; 17) from a lower position of the headrest (3) initially effecting a limited displacement of the at least one tube (6a, 6b) and thus a displacement of the headrest (3) into an upper position, and with a further actuation of the drive means (8; 18) effecting a displacement of the rod (7c, 7d) relative to the tube (6a, 6b) under compression of the spring element (12, 13), so that the headrest (3) is tilted.

7. The adjustment device as set forth in claim 1, characterized in that the tube (6a, 6b) has a stop (14, 15) that cooperates with at least one abutment that is provided on the frame (5) in order to limit the translational movement of the tube (6a, 6b).

8. The adjustment device as set forth in claim 1, characterized in that the at least one drive unit comprises a first and a second drive unit (17, 18), with the first drive unit (17) being coupled with the tube (6a, 6b) for the purpose of displacing same and the second drive unit (18) being coupled with the rod (7c, 7d) for the purpose of displacing same relative to the tube (6a, 6b).

9. The adjustment device as set forth in claim 8, characterized in that the first drive unit (17) is coupled via a first fastening element (11) with the tube (6a, 6b) and the second drive unit (18) is supported on the first fastening element (11).

10. The adjustment device as set forth in claim 1, characterized in that the height adjustment device (6) comprises two tubes (6a, 6b) that are mounted parallel to one another and are slidably supported in the frame, with two rods (7c, 7d) also being provided accordingly and each of the two tubes (6a, 6b) being guided in one of the two rods (7c, 7d).
